(19) United States
(12) Patent Application Publication
(10) Pub. No.: US 2018/0066978 A1
(43) Pub. Date: Mar. 8, 2018

(54) Cart Weight Sensing System

(71) Applicant: Wal-Mart Stores, Inc., Bentonville, AR (US)

(72) Inventor: Andrew B. Millhouse, Phoenix, AZ (US)

(21) Appl. No.: 15/688,041

(22) Filed: Aug. 28, 2017

Related U.S. Application Data
(60) Provisional application No. 62/384,937, filed on Sep. 8, 2016.

(51) Int. Cl. G01G 19/02; G01G 7/00; G01G 7/02; G08B 1/08

(52) U.S. Cl. CPC G01G 19/024; G08B 1/08; G01G 7/02; G01G 7/00

(57) ABSTRACT

Described in detail herein are a system and an apparatus for detecting weight in cart. A display and reader coupled to a cart can scan and decode a identifier of a machine-readable element associated with a physical object. The cart can transmit the identifier to a computing system the computing system can query the database to retrieve a stored weight of the physical object. The physical object be placed in the basket of the cart and a transducer coupled to the cart and determine the weight of the physical object of the cart. The computing system can determine physical object placed in the basket is the same as the last scanned physical object in response to determining the weight of most recently scanned physical object is within a predetermined threshold of the weight of the physical object in the basket.

### CROSS-REFERENCE TO RELATED PATENT APPLICATIONS

This application claims priority to U.S. Provisional Application No. 62/384,937 filed on Sep. 8, 2016, the content of which is hereby incorporated by reference in its entirety.

### BACKGROUND

Autonomous tracking physical objects carried in carts can be an error-prone and difficult process. The physical objects are constantly subject to loss and being stolen.

### BRIEF DESCRIPTION OF DRAWINGS

Illustrative embodiments are shown by way of example in the accompanying drawings and should not be considered as a limitation of the present disclosure:

FIG. 1A is a block diagram of an exemplary cart implementing a weight sensing system according to the present disclosure;

FIG. 1B is a block diagram of an electrical circuit of the cart according to the present disclosure;

FIG. 1C illustrates an exemplary caster the cart according to the present disclosure;

FIG. 1D illustrates a perspective view of an electromagnetic generator of a caster of the weight sensing system according to the present disclosure;

FIG. 1E illustrates a front view of an electromagnetic generator of a caster of the weight sensing system according to the present disclosure;

FIG. 1F illustrates an exemplary connection ports for recharging an internal power source of the electric circuit according to the present disclosure;

FIG. 1G illustrates an exemplary display of the cart of the weight sensing system according to the present disclosure;

FIG. 1H illustrates an exemplary sensors of the cart of the weight sensing system according to the present disclosure;

FIG. 1I illustrates an exemplary mat for charging a battery of the cart of the weight sensing system according to the present disclosure;

FIG. 2 illustrates an exemplary physical object verification system in accordance with exemplary embodiments of the present disclosure;

FIG. 3 illustrates an exemplary computing device in accordance with exemplary embodiments of the present disclosure; and

FIG. 4 is a flowchart illustrating a process of the weight sensing system exemplary embodiments of the present disclosure.

### DETAILED DESCRIPTION

Described in detail herein are systems, methods, and apparatus for detecting weight in a cart. The cart can include an electric circuit having a display and reader coupled to a cart. The reader can scan and decode an identifier of a machine-readable element associated with a physical object to be placed in the cart and the cart can transmit the identifier (via the electric circuit) to a computing system. The computing system can query a database to retrieve a stored weight of the physical object. When the physical object is placed in the cart (e.g., in the basket or on the frame), one or more transducers in the electric circuit can determine the weight of the physical object in the cart. The electric circuit of the cart can transmit the sensed weight of the physical object to the computing system. The computing system can determine the identity of the physical object placed in the cart is the same as the identity of the last scanned physical object in response to determining the stored weight of most recently scanned physical object is within a predetermined threshold of the sensed weight of the physical object in the cart.

Exemplary embodiments include a system for sensing weight. The system includes a (first) cart. The cart includes a frame, a basket supported by the frame, two front casters supporting the frame, and two rear casters supporting the frame. Each of the front two caster and the rear two caster include a housing configured to be coupled to the frame and a wheel rotatable coupled to the housing.

The cart further includes an electric circuit distributed throughout the first cart. The electrical circuit can include, a battery, a reader, a display, transducers, a wireless receiver, a wireless transmitter, an electromagnetic generator and a controller. The battery is configured to power the electric circuit. At least one of the transducers in the group is disposed in the housing of each of the two front caster and the two rear caster. The group of transducers are configured to output electrical signals in response to an applied pressure or force. The transducers is can be positioned in the casters to be between the frame and the housing of the casters such that the weight of the basket and the frame of the cart compresses the transduced between frame of the cart and the housing of the caster. The reader is configured to read machine-readable elements associated with physical objects being placed on the first cart. The controller is configured to control the reader to read the machine-readable elements, receive the electrical signals output by the group of transducers and determine a measured/sensed weight of the physical object being placed on the cart.

The electromagnetic generator is operatively coupled to the controller and the wheel of at least one of the two front casters or at least one of the two rear casters. In exemplary embodiments, an electromagnetic generator can be included in the electric circuit for each of the wheels or for one or more of the wheels. The electromagnetic generator is configured to output an electrical current in response to rotation of the wheel (e.g. the rotation of the wheel can drive the shaft of the electromagnetic generator such that a magnet and conductive coil of the electromagnetic generator move relative to each other). The controller can configured to transition from a first mode of operation to a second mode of operation in response to receiving the electrical current from the electromagnetic generator. For example, the controller can power down the display (and/or other components of the electric circuit) in the first mode of operation and can power on the display (and/or other components of the electric circuit) in the second mode of operation. The controller can transition from the first mode of operation to the second mode of operation in response to the electrical current exceeding a threshold current value.

The measured/sensed weight by the transducers can correspond to a combined weight of the physical objects that have been placed on the cart. The controller can aggregate stored weight values for each of the physical object placed in the cart (e.g., based on previous identification of the physical objects in the cart), and can determine a difference between the combined weight and an aggregation of the store weight values. In response to determining the difference is greater than a threshold difference, the computing system is programmed to transmit an alert.

The wireless transmitter is operatively coupled to the controller to transmit first data, and the wireless receiver is operatively coupled to the controller to receive second data in response to transmission of the first data. The controller can control the display to render at least a portion of the second data. The first data can include an identifier encoded in a first machine-readable element read by the reader and the second data can include a stored weight value for a first physical object associated with the first machine-readable element read by the reader. The controller can be configured to determine whether the first physical object is placed on the cart based on a comparison between the stored weight value and the measured/sensed weight of the first physical object.

A computing system can be in communication with the cart to receive the first data, query a database to retrieve the second data, and transmit the second data to the electrical circuit. The first data can include the measured/sensed weight, and the computing system can be configured to determine whether the measured/sensed weight corresponds to a stored weight value of a first physical object associated with a first machine-readable element read by the reader.

The electrical circuit further includes a first connection port operatively coupled to a first terminal of the battery and a second connection port operatively coupled to a second terminal of the battery. An external power source can be operatively coupled to at least one of the first connection port or the second connection port to charge the battery. One of the first connection port or the second connection port can be disposed proximate a rear end of the frame of the (first) cart and is the other connection port can be disposed proximate to the a front end of the frame of the first cart. The system further includes a second cart configured to be electrically coupled to the first cart via at least one of the first connection port or the second connection port.

Exemplary embodiments can also include, a cart apparatus including a frame having a handle portion defining a rear end of the cart, a basket supported by the frame and disposed forward of the handle portion and a front end of the basket defining a front end of the cart. The cart includes two front casters supporting the frame and two rear casters supporting the frame. Each of the two front casters and the two rear casters including a housing configured to be coupled to the frame and a manually driven wheel operatively coupled to the housing. The cart further includes an electric circuit distributed throughout the cart, the electric circuit including, a battery configured to power the electric circuit, a first connection port disposed proximate to and forward of the rear end or proximate to and rearward of the front end of the cart and below the basket, a second connection port disposed proximate to and forward of the rear end or proximate to and rearward of the front end of the cart and below the basket. The first connection port being operatively coupled to a first terminal of the battery and the second connection port being operatively coupled to a second terminal of the battery.

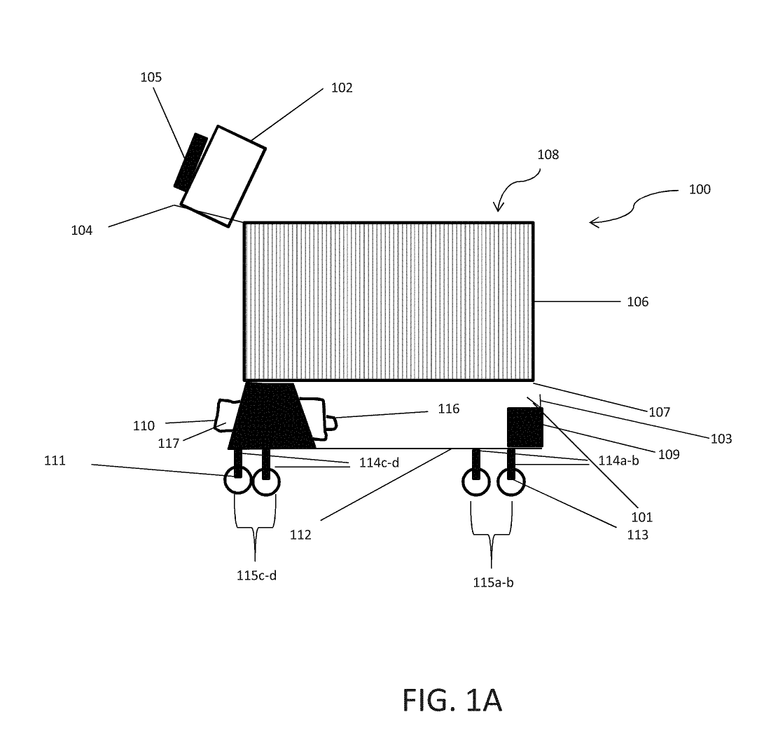

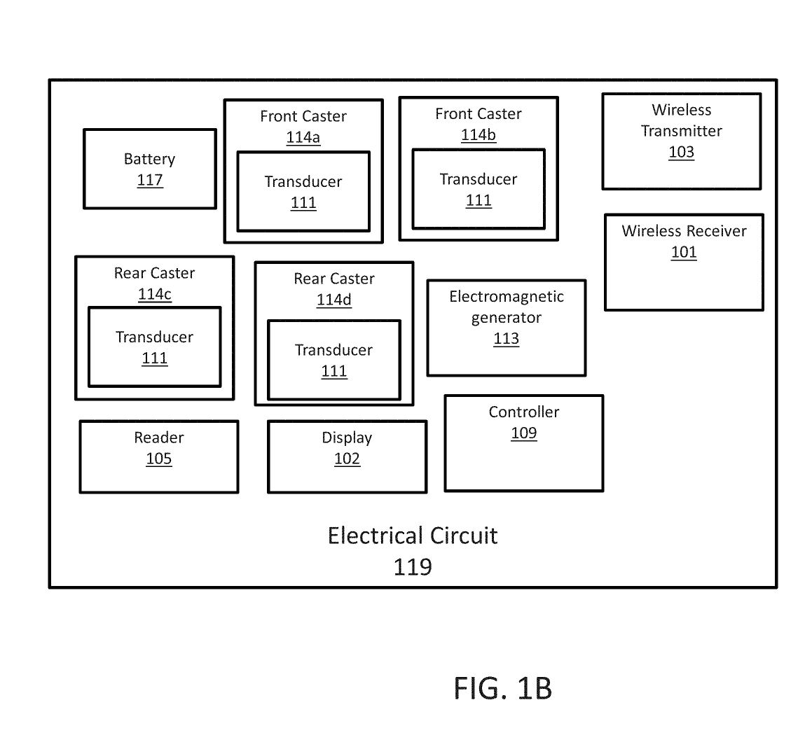

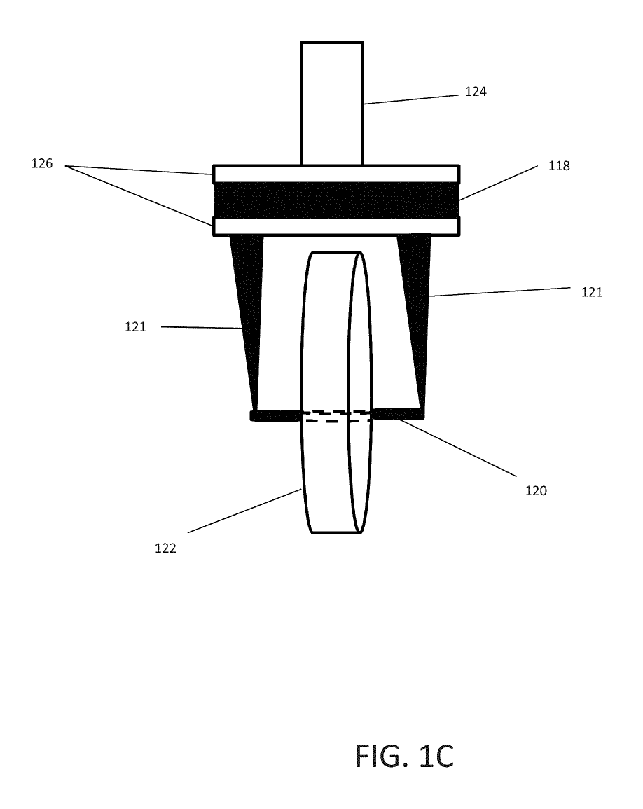

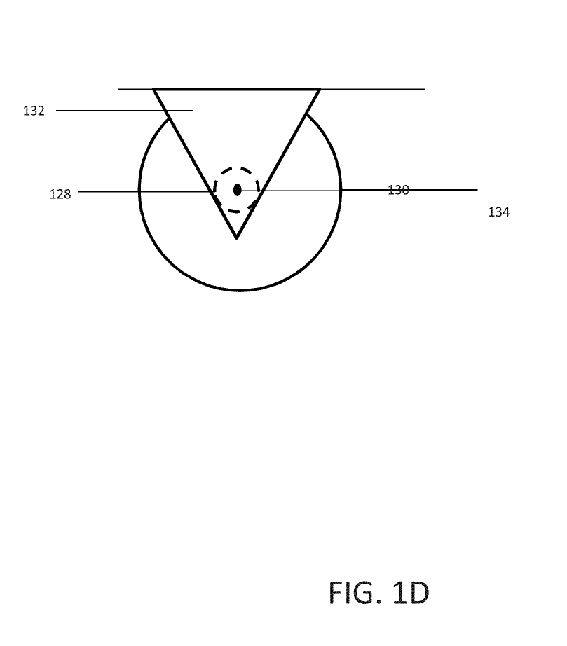

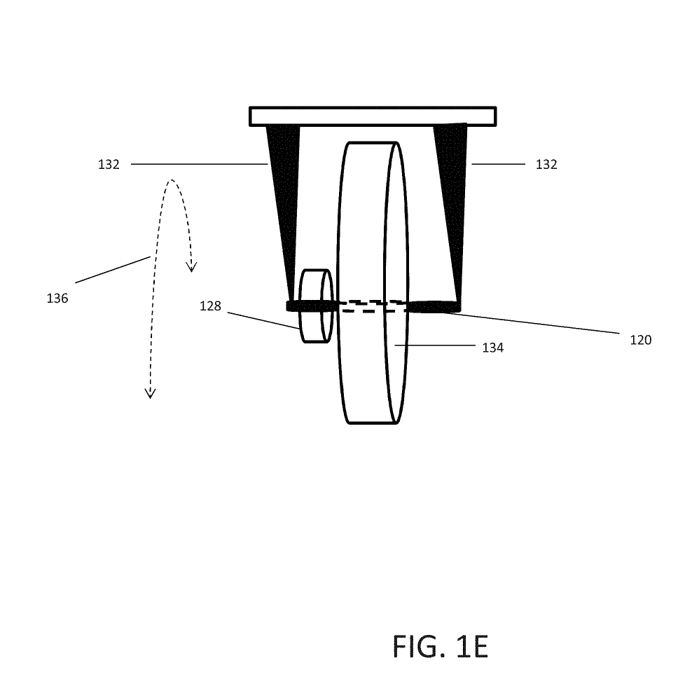

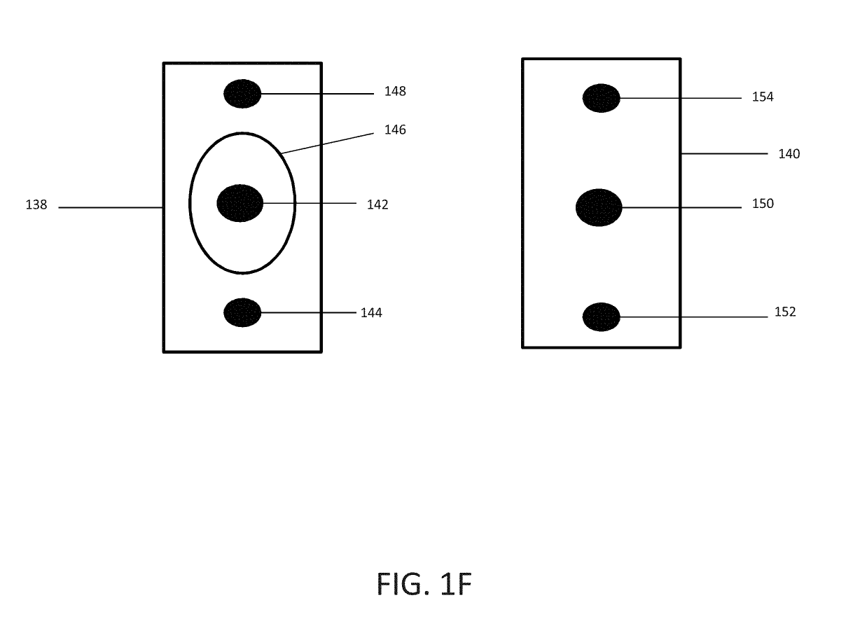

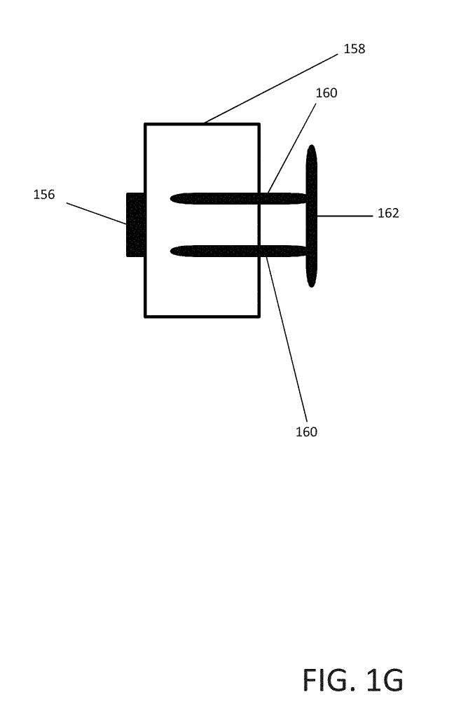

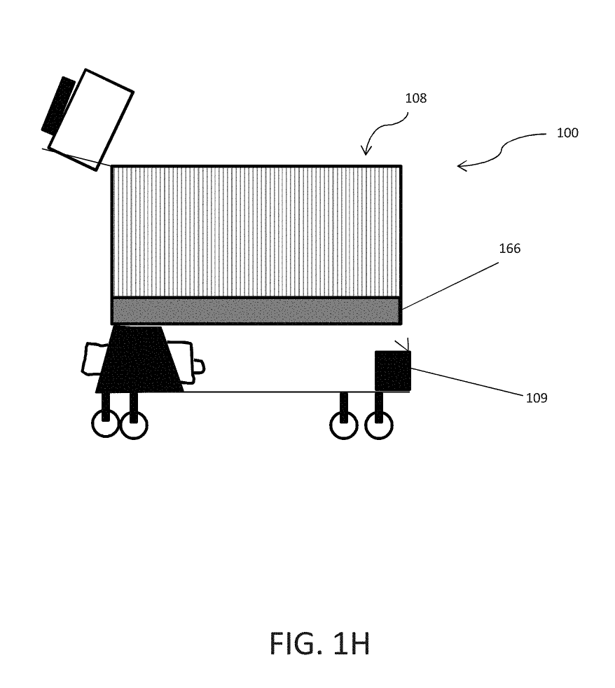

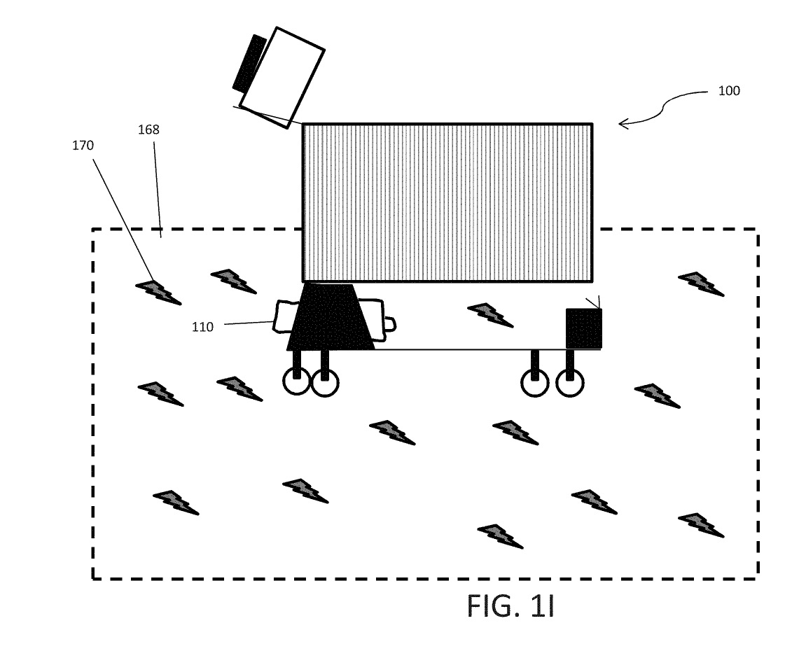

FIG. 1A is a block diagram of an exemplary a cart 100 implementing the weight sensing system according to the present disclosure. FIG. 1B is a block diagram of an electrical circuit 119 of the cart according to the present disclosure. Referring to FIGS. 1A and 1B, the cart 100 can include a frame 107, a basket 106 supported by the frame 107, two front casters 114a supporting the frame 107, and two rear casters 114a-b supporting the frame 107. Each of the front two casters 114a-b and the rear two casters 114c-d can include a housing coupled to the frame 107 and a wheel 115a-d rotatable coupled to the housing. The electric circuit 119 distributed throughout the cart 100, and can include, a battery 117, transducers 111 disposed in the front casters 114a-b and the rear casters 114c-d, a reader 105, a display screen 102, a controller 109, wireless transmitter 103, wireless receiver 101, and electromagnetic generators disposed in the front casters 114a-b and the rear casters 114c-d.

The battery 117 can be configured to power the electric circuit 119. The transducers 111 can be disposed in the housings of the two front casters 114a-b and housings of the two rear casters 114c-d. The transducers 111 can output electrical signals in response to an applied pressure or force. The controller 109 can be configured to control transducers 111, display 102 and the reader 105. The reader 105 can be an optical scanner configured to scan machine-readable elements such as barcodes or QR codes. The display 102 can be an flat panel display device (e.g., using LED, OLED or LCD technology).

The battery 117 can be disposed below the basket 106 of the cart 100 supported by a base 112 of the frame 107. A first connection port 116 can be electrically connected to one terminal of the battery and a second connection port 110 can be electrically connected to a second terminal of the battery. The first connection port 116 can be a male port disposed proximate to, and forward of, the rear end of the cart 100. The second connection port 110 can be a female port disposed proximate to, and to the rearward to of, the front end of the cart 100. The display 102 and reader 105 can be mounted on the handle 104 of the cart 100. The front of the display can face away from the basket 106.

As an example, the reader 105 can be configured to scan machine-readable elements affixed to and associated with an physical object. The display 102 can display information associated with the physical object, and the physical object can be placed into the volume 108 of the basket 106 or on the frame 107 (e.g., under the basket on the base 112. The physical object placed in the basket 106 or on the frame can apply a pressure or force on the front and rear casters 114a-d. In response to detecting this increase in pressure or force resulting from the physical object being placed in the basket 106 or on the frame 107, the controller 109 can receive electrical signals produced by the transducers 111 corresponding to the pressure or force, and can determine the weight of the physical object placed in the basket 106 based on the electrical signals.

The basket 106 can receive multiple physical objects. The controller 109 can determine the aggregate weight of the physical objects as the physical objects are placed in the cart and can store the aggregate weight. In response to receiving a new physical object in the basket 106 or on the frame 107 of the cart 100, the controller 109 can calculate the difference between the stored aggregate weight and the new aggregate weight to determine the weight of the newly added physical object. Alternatively, the controller 109 can determine whether a physical object has been removed from the cart based on the difference of a new aggregate weight and the stored aggregate weight when the weight in the cart 100 is reduced. A wireless transmitter 103 can be coupled with the controller 109 to transmit data to a computing system and a wireless receiver 101 can be coupled with the controller 109 to receive data.

FIG. 1C illustrates an exemplary caster 126 of the cart according to the present disclosure. The caster 126 can include a housing 121 configured to be coupled to the frame of the cart and the wheel 122 of the caster 126 is configured to be rotatably coupled to the housing 121. A transducer 118 can be positioned between frame 124 of the cart and the housing 121. For example, the housing 121 can include two sections: an upper section that is disposed above the transducer 118 and a lower section that is disposed below the transducer. The upper and lower sections of the housing 121 can be slidingly engaged and arranged to move relative to each other such that when a force is applied to the housing 121, the upper section of the housing moves towards the lower section of the housing and compresses the transducer 118. The wheel can be secured to the housing 116 via a shaft 120.

The transducer 118 can be a sensing device, such as a piezoelectric device, configured to generate an electric signal that corresponds to a pressure or force applied to the transducer 118 (e.g., caused by something placed in the cart). The transducer 118 can generate an electrical signal whose magnitude is proportionate to the pressure or force being applied. In some embodiments, the transducer 118 can be an active sensor, a passive sensor, an actuator, or bidirectional. The active sensor requires an external power source, such as the battery as shown in FIG. 1A.

As an example, the cart 100 as shown in FIG. 1A, can receive a physical object in the volume of the basket 106 or on the frame 107. In response to receiving the physical object, pressure or force can be applied by the weight of the physical object to the caster supporting the frame 124 and basket of the cart. The transducer 118 can detect the pressure and determine the amount of force being applied to the caster 126. The transducer 118 can generate an electrical signal proportionate to the force being applied to the caster by the weight of the physical object and transmit the electrical signal to the controller. The controller can determine the weight of the physical object in cart.

FIGS. 1D-1E illustrate an exemplary electromagnetic generator 128 of the caster according to the present disclosure. The electromagnetic generator 128 can be disposed with respect to the housing 132 and the wheel 134.

Turning to FIG. 1E a front view of the electromagnetic generator 128 secured to the housing of the caster is illustrated. The electromagnetic generator 128 can output an electrical current in response to the rotation of the wheel 134. The wheel 134 can rotate in a frontward or backward direction as indicated by the arrows 136. For example, the shaft 120 can be coupled to the wheel 134 and can rotate with the wheel 134. The shaft can form part of the electromagnetic generator 128 and can include, for example, a magnet disposed at a terminal end, which can be surrounded by a conductive coil such that rotation of the shaft causes the magnet to rotate with respect to the conductive coil and results in an electrical current being induced in the conductive coil. The controller can receive the electric current from the electromagnetic generator 128 and can control a mode of operation of the electric circuit of the cart in response to the electrical current. In one example, the controller can power on the display and reader, shown in FIG. 1A, in response to the rotation of the wheels and receiving an electrical current and can power down the display and the reader when the cart is stationary (e.g., when no electric current is being generated by the electromagnetic generator). A threshold electric current can be specified such that the controller can power on the display and the reader in response to receiving an electrical current that exceeds the threshold. In some embodiments, controller can be configured to wait to power on the display and reader for time period after the threshold is (continuously or otherwise) exceeded and/or can wait to power down the display and reader for a time period after the threshold is no longer exceeded.

In another example, the controller can power down display and reader when the wheels are rotating and cart is in motion. The controller can store power being produced by the electromagnetic generator 128 upon rotation of the wheels (e.g., by charging the battery or a capacitor). The controller can use the stored power to power on the display and the reader when the wheels are not rotating and the cart is stationary.

FIG. IF illustrates exemplary connection ports of the cart according to the present disclosure. As described herein, embodiments of the cart can include a first connection port electrically coupled to a first terminal of the battery (e.g., a positive terminal) and a second connection port electrically coupled to a second terminal the battery (e.g., a negative terminal). The first connection port can be male connection port and the second connection port can be a female connection port. For example, the first connection port 140 can be a male connection port of a battery disposed on can include a male connector 150. The second connection port 138 can be a female connection port of a battery and can include an aperture or receptacle 142 that receives and holds the “male” connector 150. Both the first and second connection ports 138-140 can include latching magnets 144,148,152,154, disposed on the top and bottom of the first and second connection ports 138-140. The first and second connection ports 138-140 can be used to charge the battery.

In one example, multiple carts can be disposed in a docking area or station in a linear fashion. One cart can be disposed behind another cart to form a chain of carts such that the male connectors of one cart can be secured to and electrically coupled with the female connector of another cart that is positioned in front of the cart in the chain of carts. The carts can also be secured to one another using the latching magnets. The carts at the ends of the chain of cart can connect to an external power supply and ground to form a closed circuit such that the batteries of the carts in the chain of carts can be charged via the port connections on the carts.

In a non-limiting example, a first cart can face a wall and the male connector of male connection port of the battery disposed in the first cart can be secured an electrical outlet can be disposed on the wall. The electrical outlet can output a continuous electrical current and the battery disposed in the cart can receive the electrical current through the male connector and charge itself and transmit the electrical current to the second cart through the female receptacle. For example, a male connector of a battery disposed in a second cart can be secured to a female receptacle of the battery disposed in the second cart. The electrical current can flow from the electrical outlet disposed on the wall to the batteries disposed on the carts disposed in the docking area or station.

FIG. 1G illustrates an exemplary display screen and reader secured to embodiments of the cart according to the present disclosure. As described herein, the display screen 158 and reader 156 can be secured to handles 160 of a frame 162 of the cart. The reader 156 and display screen 158 can be communicatively coupled to the controller. The controller can control the reader to scan machine-readable elements. The controller can control the display screen 158 to display information associated with the scanned machine-readable elements. The display screen 158 can also be configured to receive inputs via touch screen or through a keyboard (not shown). The display screen 158 and the reader 156 can be powered on and off based on the electrical current as received shown in FIGS. 1D-1E and/or in response to actuation of a power switch. In some embodiments, the controller can control the display screen 158 to render the weight inside the basket of the cart as the weight fluctuates based on physical objects removed and added to the cart.

FIG. 1H illustrates exemplary sensors of an embodiment of the cart 100 implementing the weight sensing system according to the present disclosure. In some embodiments, weight sensors 166 can be disposed at the base of the basket 108 of the cart 100. The weight sensor 166 can be an individual sensor extending through the base of the cart. In other embodiments, the weight sensor 166 can be multiple weight sensors disposed throughout the base of the cart. In some embodiments, the weight sensors 166 can be disposed in a pad or a mat that lines the based on the basket 108. The weight sensors 166 can be configured to detect and determine the weight of physical object placed inside the cart. The weight sensor 166 can be coupled with the controller 109. The controller can transmit the determined weight of the physical objects within the basket of the cart to the computing system.

FIG. 11 illustrates an exemplary charging station 168 for inductively charging the battery 110 of the cart 100 implementing the weight sensing system according to the present disclosure. In some embodiments, the charging station 168 can be implemented as one or more mats 168 disposed in the facility to provide wireless charging to the battery 110 of the cart 100 using inductive coupling. In some embodiments, the charging station 168 can be integrated on or in the floor of the facility. The charging station 168 can be configured to generate an electromagnetic field 170 to transfer energy to the battery 110 of the cart 100 via the charging station 168.

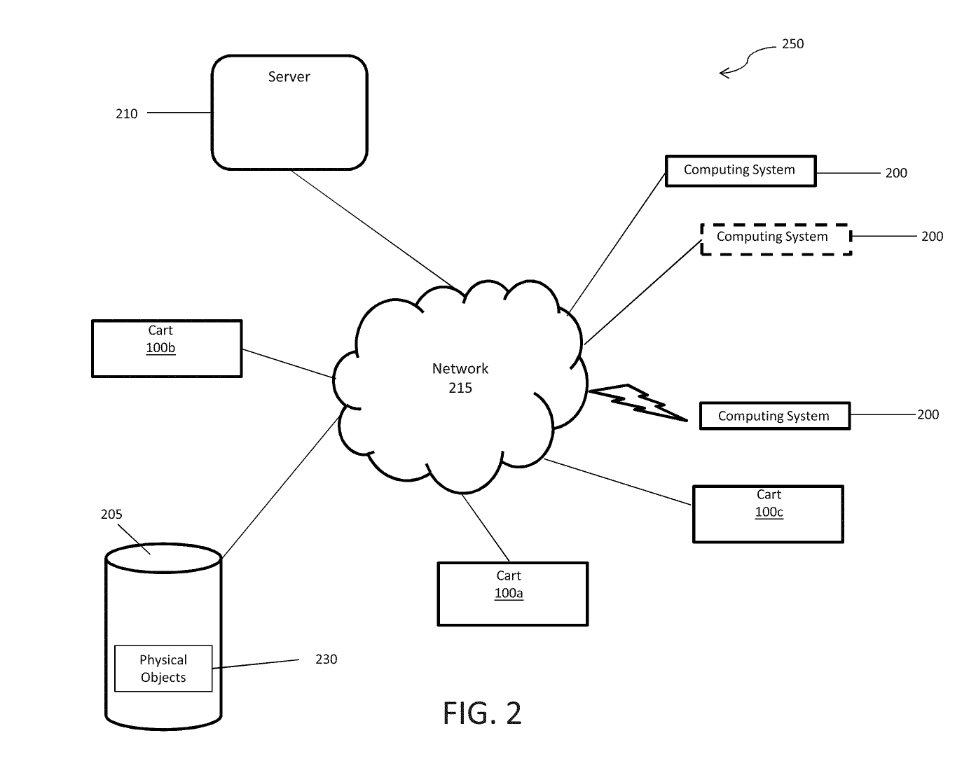

FIG. 2 illustrates an exemplary physical object verification system 250 in accordance with exemplary embodiments of the present disclosure. The physical object verification system 250 can include one or more databases 205, one or more servers 210, one or more computing systems 200 and carts 100a-c. In exemplary embodiments, the computing system 200 is in communication with the databases 205, a server 210, and the carts 100a-c, via a communications network 215.

In an example embodiment, one or more portions of the communications network 215 can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The server 210 and the databases 205 are connected to the communications network 215 via a wired connection. Alternatively, the server 210 and the databases 205 can be connected to the network 215 via a wireless connection. The server 210 includes one or more computers or processors configured to communicate with the computing system 200 and the databases 205, via the network 215. The server 210 hosts one or more applications configured to interact with one or more components computing system 200 and/or facilitates access to the content of the databases 205. The databases 205 may store information/data, as described herein. For example, the databases 205 can include an physical objects database 230. The physical objects database 230 can include information associated with physical objects disposed in facilities (e.g., such as unique identifiers associated with the physical objects, names of the physical object, types of the physical objects, stored weights of the physical objects, and stored images of the physical objects). The databases 205 and server 210 can be located at one or more geographically distributed locations from each other or from the computing system 200. Alternatively, the databases 205 can be included within server 210.

In exemplary embodiments, the cart 100a can be moved through a facility in which a plurality of physical objects are disposed. The computing system 200 can receive an identifier decoded from a machine-readable element associated with a physical object from the cart 100a (e.g., via the electric circuit). The computing system 200 can query the physical objects database to retrieve information regarding the physical object based in the identifier. The information can include, but is not limited to: a name of the physical object, a type of physical object, a stored weight of the physical object and a stored image of the physical object. The computing system 200 can transmit the information back to the cart 100a. The 100a can display the information on the display screen.

The computing system 200 can receive a measured/sensed weight from the cart 100a and can compare the stored weight of the physical object and the weight received from the cart 100a. The computing system can determine the physical object scanned by the optical scanner has been placed in the basket of the cart 100a in response to the received measured/sensed weight being within a threshold amount of the stored weight.

The computing system 200 can store the weight of physical objects kept in the cart 100a and can aggregate the weight of the physical objects and calculate the aggregate stored weight of the scanned physical objects. The computing system 200 can compare the aggregate weight in the at least one cart and the aggregate stored weight of the scanned physical objects. The computing system 200 can determine how many of the scanned physical objects are being placed into the cart 100a. In some embodiments, the computing system 200 can transmit an alert in response to determining the weight of the aggregate physical objects is greater or less than the aggregate stored weight of the physical objects by more than a threshold amount.

As a non-limiting example, the physical object verification system 250 can be implemented in a retail store. The carts 100a-c can be shopping carts operated by customers within the retail store. The customers can scan machine-readable elements products using the optical scanner on the shopping carts 100a-c. The carts 100a-c can send identifiers associated with the products to the computing system 200 (e.g., via the electrical circuits in the carts). The computing system 200 can query the physical objects database 230 to retrieve information associated with the products. The information can be but is not limited to, product name, brand, price, stored image and a stored weight. The computing system 200 can transmit at least a portion of the information to the shopping carts 100a-c from which the identifiers are received. The shopping carts 100a-c can display the received information on the display screen.

The computing system 200 can receive determined weights of products in the carts from the shopping cart 100a-c (e.g., via the electric circuit) including the weight of the product most recently placed in each of the carts 100a-c. The computing system 200 can compare the weight of each of the products most recently placed in each of the carts 100a-c to the stored weights of each of the most recently scanned products. The computing system 200 can determine each of the most recently scanned product is the same as each of the most recently added products to each respective cart in response to the weights received from each of the carts 100a-c being within a threshold amount of the stored weights of each of the most recently scanned products.

In some embodiments, the customer can checkout and pay for the products using the display screen on the shopping carts 100a-c. For example, the customer using the cart 100a can enter their payment card information using the display screen on the cart 100a. The cart 100a can transmit the payment information and a total aggregate weight in the cart 100a to the computing system 200. The computing system 200 can identify the products to be purchased and query the weight of each of the products as described herein. The computing system 200 can calculate an aggregate stored weight for all of the products to be purchased and compare the aggregate stored weight to the received aggregate total measured/sensed weight within the basket of the shopping cart 100a. The computing system 200 can transmit an alert in response to determining the difference of the aggregate stored weight and the received aggregate total measured/sensed weight within the basket of the at least one shopping cart 100a-c is not within a predetermined threshold amount. In response to determining the difference of the aggregate stored weight and the received aggregate total measured/sensed weight for the cart 100a is within a threshold amount, the computing system 200 can process the payment information and transmit a receipt to be displayed on the display screen of the at least one shopping cart. The receipt can include all the products purchased along with a machine-readable element encoded with an identifier associated with the entire transaction.

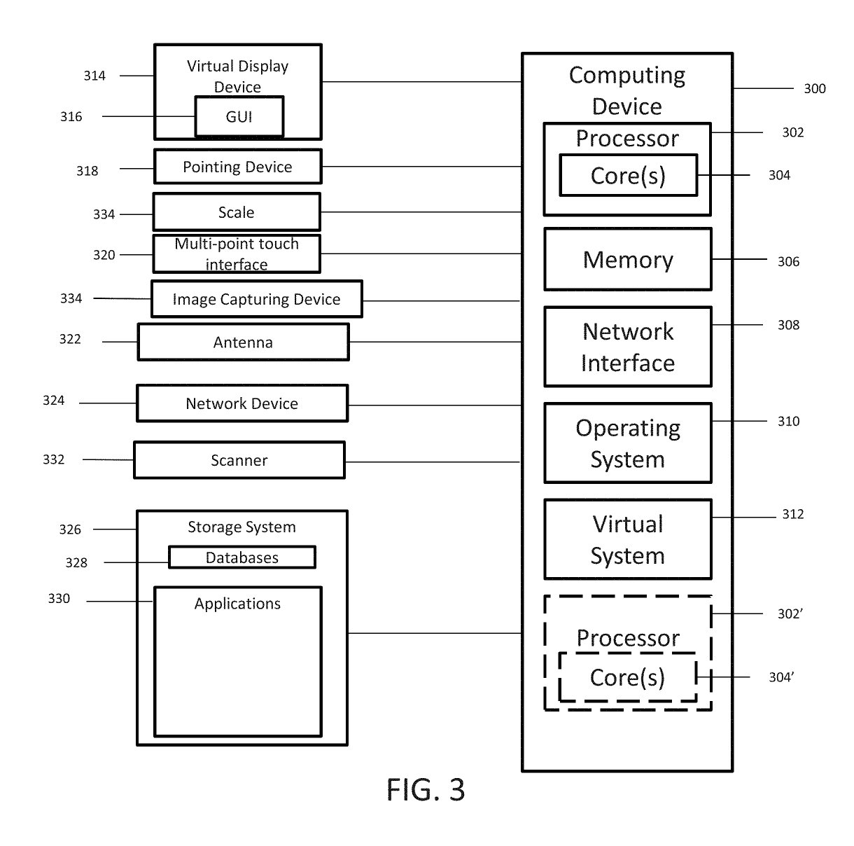

FIG. 3 is a block diagram of an example computing device for implementing exemplary embodiments of the present disclosure. Embodiments of the computing device 300 can implement embodiments of the weight sensing system. The computing device 300 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 306 included in the computing device 300 may store computer-readable and computer-executable instructions or software (e.g., applications 330) for implementing exemplary operations of the computing device 300. The computing device 300 also includes configurable and/or programmable processor 302 and associated core(s) 304, and optionally, one or more additional configurable and/or programmable processor(s) 302′ and associated core(s) 304′ (for example, in the case of computer systems having multiple processors/cores), for executing computer-readable and computer-executable instructions or software stored in the memory 306 and other programs for implementing exemplary embodiments of the present disclosure. Processor 302 and processor(s) 302′ may each be a single core processor or multiple core (304 and 304′) processor. Either or both of processor 302 and processor(s) 302′ may be configured to execute one or more of the instructions described in connection with computing device 300.

Virtualization may be employed in the computing device 300 so that infrastructure and resources in the computing device 300 may be shared dynamically. A virtual machine 312 may be provided to handle a process running on multiple processors so that the process appears to be using only one computing resource rather than multiple computing resources. Multiple virtual machines may also be used with one processor.

Memory 306 may include a computer system memory or random access memory, such as DRAM, SRAM, EDO RAM, and the like. Memory 406 may include other types of memory as well, or combinations thereof.

The computing device 300 can receive data from input/output devices such as, a scanner 332, an image capturing device 334, and a scale 336.

A user may interact with the computing device 300 through a visual display device 314, such as a computer monitor, which may display one or more graphical user interfaces 316, multi touch interface 320 and a pointing device 318.

The computing device 300 may also include one or more storage devices 326, such as a hard-drive, CD-ROM, or other computer readable media, for storing data and computer-readable instructions and/or software that implement exemplary embodiments of the present disclosure (e.g., applications). For example, exemplary storage device 326 can include one or more databases 328 for storing information regarding the physical objects. The databases 328 may be updated manually or automatically at any suitable time to add, delete, and/or update one or more data items in the databases. The databases 328 can include information associated with physical objects disposed in the facility.

The computing device 300 can include a network interface 308 configured to interface via one or more network devices 324 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 322 to facilitate wireless communication (e.g., via the network interface) between the computing device 300 and a network and/or between the computing device 300 and other computing devices. The network interface 308 may include a built-in network adapter, network interface card, PCMCIA network card, card bus network adapter, wireless network adapter, USB network adapter, modem or any other device suitable for interfacing the computing device 300 to any type of network capable of communication and performing the operations described herein.

The computing device 300 may run any operating system 310, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device 300 and performing the operations described herein. In exemplary embodiments, the operating system 310 may be run in native mode or emulated mode. In an exemplary embodiment, the operating system 310 may be run on one or more cloud machine instances.

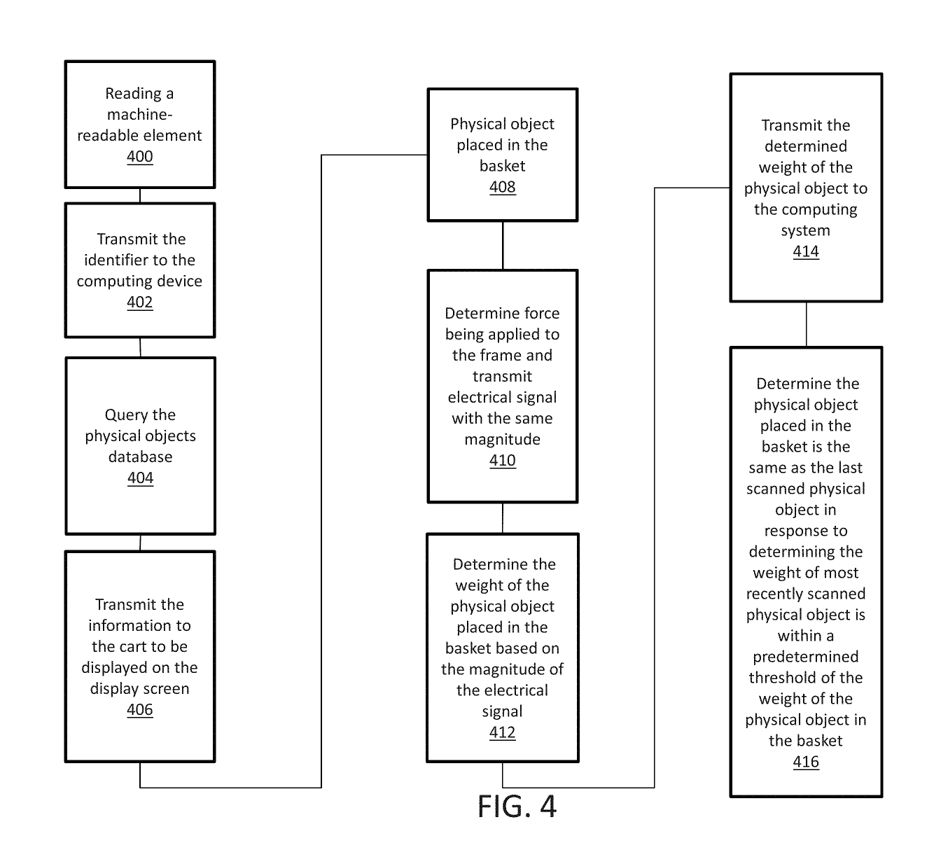

FIG. 4 is a flowchart illustrating a process of implementing a weight sensing system according to exemplary embodiments of the present disclosure. In operation 400, a controller (e.g. controller shown in FIG. 1A 109) disposed on a cart (e.g. cart as shown in FIG. 1A 100) can power on a display (e.g. display as shown in FIG. 1A 102) and a reader (e.g. reader as shown in FIG. 1A 105) based on an electrical current created by the electromagnetic generator (e.g. electromagnetic generator as shown in FIG. 1D 128). The controller can control the reader to scan and decode an identifier from a machine-readable element associated with a physical object. In operation 402, the controller can transmit the identifier to the computing device (e.g. computing device as shown in FIG. 2 200).

In operation 404, the computing system can query the physical objects database (e.g. physical objects database as shown in FIG. 2 230) using the identifier to retrieve information associated with the scanned physical object. The information can be but is not limited to, a name of the physical object, a type of physical object, a stored image and a stored weight. In operation 406, the computing system can transmit the information back to the cart to be displayed on the display screen. In operation 408, the physical object can be placed in the basket (e.g. basket shown in FIG. 1A 106) of the cart. In operation 410, one or more transducers (e.g. transducer shown in FIG. 1B 118) positioned in between the frame (e.g. frame shown in FIG. 1A 107 and FIG. 1B 124) and the caster(s) can sense an increase of force being applied to the caster(s) by the frame and basket of the cart. The transducer(s) can convert the magnitude of the force being applied into an electrical signal and transmit the electrical signal to the controller. In operation 412, the controller can determine the weight of the physical object placed in the basket based on the magnitude of the electrical signal.

In operation 414, the controller can transmit the determined weight of the physical object to the computing system. In operation 416, the computing system can determine the identity of the physical object placed in the cart is the same as the identity of the last scanned physical object in response to determining the stored weight of most recently scanned physical object is within a predetermined threshold of the measured/sensed weight of the physical object in the cart as determined by the controller.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

We claim:

1. A weight sensing system, the system comprising,
a first cart, the first cart including a frame, a basket supported by the frame, two front casters supporting the frame, and two rear casters supporting the frame, each of the front two caster and the rear two caster including a housing configured to be coupled to the frame and a wheel rotatable coupled to the housing; and
an electric circuit distributed throughout the first cart, the electric circuit including:
a battery configured to power the electric circuit;
a plurality of transducers, at least one of the plurality of transducers being disposed in the housing of each of the two front caster and the two rear caster, the plurality of transducers being configured to output electrical signals in response to pressure;
a reader mounted on the frame or the basket, the reader being configured to read machine-readable elements associated with physical objects being placed on the first cart; and
a controller operatively coupled to the battery, the plurality of transducers, and the reader, the controller being configured to control the reader to read the machine-readable elements, receive the electrical signals output by the plurality of transducers; and
determine a measured weight of the physical object being placed on the first cart.

2. The system of claim 1, wherein at least one of the plurality of transducers is disposed in the housing of one of the two rear caster or one of the two front caster so that the at least one of the plurality of transducers is positioned between the frame and the housing.

3. The system of claim 1, wherein the electric circuit further comprises:
an electromagnetic generator operatively coupled to the controller and the wheel of at least one of the two front casters or at least one of the two rear casters,
wherein the electromagnetic generator is configured to output an electrical current in response to rotation of the wheel, and
wherein the controller is configured to transition from a first mode of operation to a second mode of operation in response to receiving the electrical current.

4. The system of claim 3, wherein the controller powers down the display in the first mode of operation and powers on the display in the second mode of operation.

5. The system of claim 3, wherein the controller transitions from the first mode of operation to the second mode of operation in response to the electrical current exceeding a threshold current value.

6. The system of claim 1, wherein the measured weight is a combined weight of the physical objects placed on the cart, the controller aggregates stored weight values for each of the physical object placed in the cart, and determines a difference between the combined weight and an aggregation of the store weight values.

7. The system of claim 1, wherein the electric circuit further comprises:
a wireless transmitter operatively coupled to the controller to transmit first data;
a wireless receiver operatively coupled to the controller to receive second data in response to transmission of the first data; and
a display operatively coupled to the controller,
wherein the controller controls the display to render at least a portion of the second data.

8. The system of claim 7, wherein the first data includes an identifier encoded in a first machine-readable element read by the reader and the second data includes a stored weight value for a first physical object associated with the first machine-readable element read by the reader, and the controller is configured to determine whether the first physical object is placed on the cart based on a comparison between the stored weight value and the measured weight of the first physical object.

9. The system of claim 7, further comprising:
a computing system in communication with the first cart to receive the first data; query a database to retrieve the second data, and transmit the second data to the electrical circuit.

10. The system of claim 9, wherein the first data includes the measured weight, and the computing system is configured to determine whether the measured weight corresponds to a stored weight value of a first physical object associated with a first machine-readable element read by the reader.

11. The system of claim 9, wherein the measured weight corresponds to a combined weight of the physical objects place on the cart, and the computing system is configured to determine whether the combined weight corresponds to an aggregation of the stored weight values associated with each of the physical objects.

12. The system in claim 11, wherein the computing system is programmed to determine whether a difference between the combined weight and the aggregation of the stored weight values is greater than a predetermined amount.

13. The system in claim 12, wherein in response to determining the difference is greater than a threshold difference, the computing system is programmed to transmit an alert.

14. The system of claim 1, wherein the electrical circuit further comprises:
a first connection port operatively coupled to a first terminal of the battery; and
a second connection port operatively coupled to a second terminal of the battery,
wherein an external power source is operatively coupled to at least one of the first connection port or the second connection port to charge the battery.

15. The system of claim 14, wherein at least one of the first connection port or the second connection port is disposed proximate a rear end of the frame of the first cart and at least one of the second connection port or the first connection port is disposed proximate to the a front end of the frame of the first cart.

16. The system in claim 15, further comprising a second cart configured to be electrically coupled to the first cart via at least one of the first connection port or the second connection port.

17. A cart apparatus comprising,
a frame having a handle portion defining a rear end of the cart;
a basket supported by the frame, the basket being disposed forward of the handle portion and a front end of the basket defining a front end of the cart;
two front casters supporting the frame;
two rear casters supporting the frame, each of the two front casters and the two rear casters including a housing configured to be coupled to the frame and a manually driven wheel operatively coupled to the housing; and
an electric circuit distributed throughout the cart, the electric circuit including:
a battery configured to power the electric circuit;
a first connection port disposed proximate to and forward of the rear end or proximate to and rearward of the front end of the cart and below the basket, the first connection port being operatively coupled to a first terminal of the battery;
a second connection port disposed proximate to and forward of the rear end or proximate to and rearward of the front end of the cart and below the basket, the second connection port being operatively coupled to a second terminal of the battery;
a reader mounted on the frame or the basket, the reader being configured to read machine-readable elements associated with physical objects being placed on the first cart;
a display mounted on the frame or the basket; and
a controller operatively coupled to the battery, the display, and the reader, the controller being configured to control the reader to read the machine-readable elements, and control the display to display the information associated the physical objects,
wherein the first connection port is configured to be electrically coupled to power connection port associated with an external power supply that configured to charge the battery and the second connection port is configured to be electrically coupled to a return of the external power supply.

18. The apparatus in claim 17, wherein the electrical circuit further comprising:
a plurality of transducers, at least one of the plurality of transducers being disposed in the housing of each of the two front caster and the two rear caster, the plurality of transducers being configured to output electrical signals in response to pressure, and
wherein the controller is operatively coupled to the plurality of transducers and is configured to, receive the electrical signals output by the plurality of transducers; and determine a measured weight of the physical object being placed on the first cart.

19. The apparatus of claim 17, wherein the electric circuit further comprises:
an electromagnetic generator operatively coupled to the controller and the wheel of at least one of the two front casters or at least one of the two rear casters,
wherein the electromagnetic generator is configured to output an electrical current in response to rotation of the wheel, and
wherein the controller is configured to transition from a first mode of operation to a second mode of operation in response to receiving the electrical current.

20. The apparatus of claim 19, wherein the controller powers down the display in the first mode of operation and powers on the display in the second mode of operation.
